(19) United States
(12) Patent Application Publication
(10) Pub. No.: US 2019/0286820 A1
(43) Pub. Date: Sep. 19, 2019

(54) APPARATUS AND METHOD FOR DETECTING CONTAINER ROOTKIT

(71) Applicants: SAMSUNG SDS CO., LTD., Seoul (KR); BOARD OF REGENTS, UNIVERSITY OF TEXAS SYSTEM, Austin, TX (US)

(72) Inventors: Ho Sang YOON, Seoul (KR); Young IL JUNG, Seoul (KR); Mi Young LEE, Seoul (KR); Wonjun LEE, San Antonio, TX (US); Nidhin ALEXANDER, San Antonio, TX (US)

(73) Assignees: SAMSUNG SDS CO., LTD., Seoul (KR); BOARD OF REGENTS, UNIVERSITY OF TEXAS SYSTEM, Austin, TX (US)

(21) Appl. No.: 15/922,747

(22) Filed: Mar. 15, 2018

(51) Int. Cl. G06F 21/56; G06F 21/54

(52) U.S. Cl. CPC G06F 21/566; G06F 2221/034; G06F 21/54

(57) ABSTRACT

An apparatus and method for detecting a container rootkit are provided. The apparatus for detecting a container rootkit according to one example embodiment of the present disclosure includes a detection target acquirer configured to acquire, as a detection target, a copy of a kernel module program configured to be executed on a host computer system, wherein the host computer system is configured to run one or more containers; and a rootkit detector configured to detect whether a rootkit is present in the detection target based on whether the detection target contains program code for modifying operation of a pre-defined kernel function.

### BACKGROUND

### 1. Field

The following description relates to a technology for detecting a rootkit in a computer system.

### 2. Description of Related Art

A rootkit is a program that allows an attacker who breaks into a computer system with malicious intent to install backdoor processes or files after having obtained root access and mask the processes or files so that such intrusion cannot be detected by an authorized administrator on the system.

With the recent development of Linux Container technology, rootkits that exploit Linux containers are also increasing. Such container rootkits can seriously damage the entire computing system by disabling isolation of the containers when the containers are run. Accordingly, a method for effectively detecting a container rootkit has become necessary.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Exemplary embodiments of the present disclosure are intended to provide a technical means for effectively detecting a rootkit that attacks a Linux container system.

In one general aspect, there is provided an apparatus for detecting a rootkit, including at least one processor configured to implement: a detection target acquirer configured to acquire, as a detection target, a copy of a kernel module program configured to be executed on a host computer system, wherein the host computer system is configured to run one or more containers; and a rootkit detector configured to detect whether a rootkit is present in the detection target based on whether the detection target contains program code for modifying operation of a pre-defined kernel function.

The copy may be object dump file created from the kernel module program.

The at least one processor may further implement an event detector configured to detect a triggering event in the host computer system, and wherein the detection target acquirer may be configured to acquire the copy of the kernel module program when the event detector detects the triggering event.

The triggering event may include at least one of: i) the kernel module program being loaded to the host computer system, ii) a new container being created in the host computer system, or iii) an operating system of the host computer system being booted.

The rootkit detector may be configured to detect the program code based on a presence of at least one of: first program code in the detection target for hooking the pre-defined kernel function, or second program code in the detection target for changing a memory address for calling the pre-defined kernel function.

The rootkit detector may be configured to determine that the rootkit is present in the detection target when the pre-defined kernel function is for allocating a process ID (PID) namespace to a first container newly created in the host computer system, and the detection target contains additional program code for injecting a PID of a second container, which is distinguished from the first container, as a parameter of the pre-defined kernel function.

The rootkit detector may be configured to determine that the rootkit is present in the detection target when the pre-defined kernel function is for allocating a network namespace to a first container newly created in the host computer system is detected, and the detection target contains additional program code for injecting a gateway address of a second container, which is distinguished from the first container, as a parameter of the pre-defined kernel function.

The rootkit detector may be configured to determine that the rootkit is present in the detection target when the pre-defined kernel function is for replacing at least a part of executable code configured to be executed on the host computer system, and the detection target contains additional program code for swapping network namespace information of a first container to network namespace information of a second container, which is distinguished from the first container.

The rootkit detector may be configured to determine that the rootkit is present in the detection target when the pre-defined kernel function is for replacing at least a part of executable code configured to be executed on the host computer system, and the detection target contains additional program code for swapping Unix TimeSharing System (UTS) namespace information of a first container to UTS namespace information of a second container, which is distinguished from the first container.

The rootkit detector may be configured to determine that the rootkit is present in the detection target when the pre-defined kernel function is for replacing at least a part of executable code of the host computer system, and the detection target contains additional program code for swapping virtual file system information of a first container to virtual file system information of a second container, which is distinguished from the first container.

In another general aspect, there is provided a method of detecting a container rootkit which is performed by a computing device including one or more processors and a memory, wherein the memory includes one or more programs to be executed by the one or more processors, the method including: acquiring, as a detection target, a copy of a kernel module program configured to be executed on a host computer system, wherein the host computer system is configured to run one or more containers; and detecting whether a rootkit is present in the detection target based on whether the detection target includes program code for modifying operation of a pre-defined kernel function.

The copy may be an object dump file created from the kernel module program.

The method may further include, before acquiring the detection target: detecting a triggering event in the host computer system, wherein the acquiring of the detection target comprises acquiring the copy of the kernel module program when the triggering event is detected.

The triggering event may be at least one of: i) the kernel module program being loaded to the host computer system, ii) a new container being created in the host computer system, or iii) an operating system of the host computer system being booted.

The program code may include at least one of: first program code in the detection target for hooking the pre-defined kernel function, or second program code in the detection target for changing a memory address for calling the pre-defined kernel function.

The detecting of the rootkit may include determining that the rootkit is present in the detection target, when the pre-defined kernel function is for allocating a process ID (PID) namespace to a first container newly created in the host computer system, and the detection target contains additional program code for injecting a PID of a second container, which is distinguished from the first container, as a parameter of the pre-defined kernel function.

The detecting of the rootkit may include determining that the rootkit is present in the detection target, when the pre-defined kernel function is for allocating a network namespace to a first container newly created in the host computer system, and the detection target contains additional program code for injecting a gateway address of a second container, which is distinguished from the first container, as a parameter of the pre-defined kernel function.

The detecting of the rootkit may include determining that the rootkit is present in the detection target, when the pre-defined kernel function is for replacing at least a part of executable code of the host computer system, and the detection target contains additional program code for swapping network namespace information of a first container to network namespace information of a second container, which is distinguished from the first container.

The detecting of the rootkit may include determining that the rootkit is present in the detection target, when the pre-defined kernel function is for replacing at least a part of executable code of the host computer system, and the detection target contains additional program code for swapping Unix TimeSharing System (UTS) namespace information of a first container to UTS namespace information of a second container, which is distinguished from the first container.

The detecting of the rootkit may include determining that the rootkit is present in the detection target, when the pre-defined kernel function is for replacing at least a part of executable code of the host computer system, and the detection target contains additional program code for swapping virtual file system information of a first container to virtual file system information of a second container, which is distinguished from the first container.

Other features and aspects will be apparent from the following detailed description, the drawings, and the claims.

### BRIEF DESCRIPTION OF THE DRAWINGS

FIG. 1 is a diagram for describing an operation method of a container rootkit.

FIG. 2 is a block diagram for describing an apparatus for detecting a container rootkit according to one exemplary embodiment of the present disclosure.

FIG. 3 is a flowchart for describing a detection rule 300 for detecting a process ID (PID) namespace injection-related rootkit in one exemplary embodiment of the present disclosure.

FIG. 4 is a diagram for describing PID namespace injection, which is one of attacking actions of the container rootkit.

FIG. 5 is a flowchart for describing a detection rule 500 for detecting a network gateway injection-related rootkit in one exemplary embodiment of the present disclosure.

FIG. 6 is a diagram for describing network gateway injection, which is one of attacking actions of a container rootkit.

FIG. 7 is a flowchart for describing a detection rule for detecting a network namespace swapping-related rootkit in one exemplary embodiment of the present disclosure.

FIG. 8 is a diagram for describing network namespace swapping, which is one of attacking actions of a container rootkit.

FIG. 9 is a flowchart for describing a detection rule for detecting UTS namespace swapping-related rootkit in one exemplary embodiment of the present disclosure.

FIG. 10 is a flowchart for describing a detection rule for detecting a rootkit related to virtual file system (VFS) swapping in one exemplary embodiment of the present disclosure.

FIG. 11 is a flowchart for describing a method of detecting a rootkit according to one exemplary embodiment of the present disclosure.

FIG. 12 is a block diagram for describing a computing environment in which a computing device suitable to be used in the exemplary embodiments is included.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

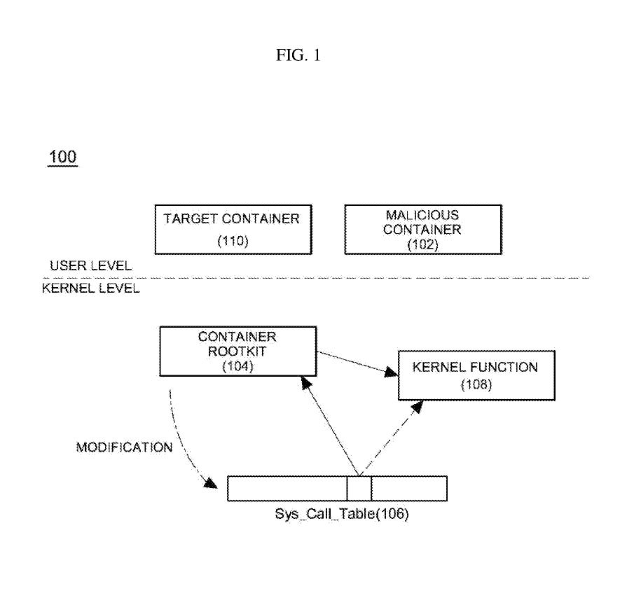

FIG. 1 is a diagram for describing an operation method of a container rootkit. A host computer system 100 runs one or more containers. The container refers to a virtualization method to execute software in an isolated environment, and may be configured to include software to be executed and a system tool, a library or the like for executing the software.

A malicious user installs a malicious container 102 in the host computer system 100 and a container rootkit 104. A rootkit is a set of software tools that an unauthorized user or malicious actor uses to attempt to gain control of a computer system without being detected. The container rootkit 104 may be hidden in the host computer system 100 in the form of a compiled loadable kernel module (LKM) program which runs in a kernel of the host computer system 100. A kernel is computer program that is the central core of the computer's operating system. It has control over everything that happens in the system. It is the first program loaded on start up. Functions or utilities which are part of standard packages may be referred to as predefined kernel functions. The LKM program is a kernel program which can be dynamically loaded to or unloaded from a currently running kernel, and is generally used to load a device driver to the kernel. For example, when the host computer program 100 is being executed in a Linux environment, a container rootkit may be a file with an extension of .ko or .o. In another exemplary embodiment, the malicious user may hide the container rootkit 104 by modifying kernel memory kmem of the host computer system 100.

The container rootkit 104 changes namespace related operations of the host computer system 100 by modifying sys_call_table 106 in the kernel. The sys_call_table 106 refers to a table storing a memory address of a kernel function 108. The container rootkit 104 may modify the memory address stored in the sys_call_table 106 (indicated by a dashed dotted arrow). As a result, the container rootkit 104 may cause the kernel function 108, for example, copy_pid_ns( ) to be executed via the container rootkit 104 (indicated by a solid arrow) rather than being directly executed (indicated by a dashed arrow). Or, by modifying the memory address stored in the sys_call_table 106, the container rootkit 104 may also cause a modified kernel function to be executed instead of the kernel function 108 (which is not modified). For example, when a target container 110 is created, the container rootkit 104 may modify a parameter of copy_pid_ns( ) which is a kernel function for assigning a namespace of the target container 110. Accordingly, the container rootkit 104 may inject a process ID (PID) namespace of the malicious container 102 into the target container 110, instead of a PID namespace of the host computer system 100, as a parent namespace. Consequently, the malicious container 102 has a process-related root authority of the target container 100 to be created. In addition to the description above, the container rootkit 104 may include a program code for performing a malicious activity, such as network sniffing, spoofing, keystroke logging, or the like, by modifying a network namespace, a mount namespace, or the like of the target container 110.

Table 1 summarizes the namespaces commonly used in Linux containers. In exemplary embodiments of the present disclosure, a namespace means a lightweight virtualization technology which provides an isolated environment as if containers running on one computer system were each running on separate, independent pieces of hardware. For example, a Linux operating system uses the following six namespaces for the isolation among containers.

TABLE 1

| Namespace | Related isolation |
|---|---|
| PID | Process ID |
| Network | Network device, stack, port |
| Mount | Mount point, file system |
| UTS | UNIX Timesharing System, hostname, domain name |
| IPC | System V IPC, POSIX message queue |
| User | User ID, group ID |

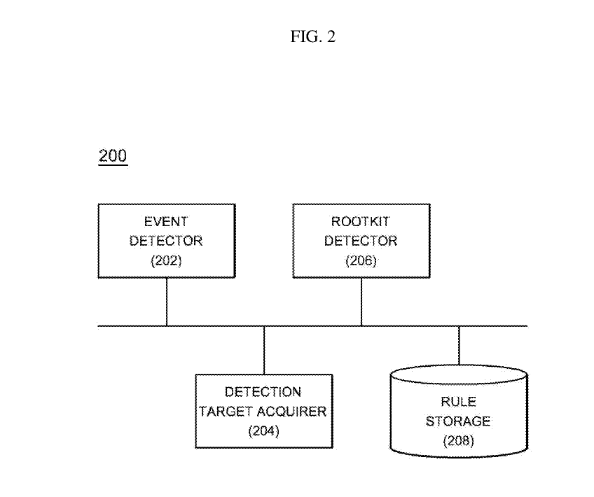

FIG. 2 is a block diagram for describing an apparatus for detecting a container rootkit according to one exemplary embodiment of the present disclosure. As shown in FIG. 2, the apparatus 200 for detecting a container rootkit includes an event detector 202, a detection target acquirer 204, a rootkit detector 206, and a rule storage 208.

In one exemplary embodiment, the apparatus 200 including the event detector 202, the detection target acquirer 204, the rootkit detector 206, and the rule storage 208 may be implemented on a computing device that includes one or more processors and a computer-readable recording medium connected to the processors. The computer-readable recording medium may be present inside or outside processors and be connected to the processors by various well-known means. The processors present inside the computing device may allow the computing device to operate according to an exemplary embodiment described herein. For example, the processors may execute an instruction stored in the computer-readable recording medium, and the instruction stored in the computer-readable recording medium may be configured to allow the computing device to execute operations according to the exemplary embodiments described herein when executed by the processors.

The event detector 202 detects the occurrence of a triggering event in the host computer system 100. According to one exemplary embodiment, the event detector 202 may determine that the triggering event has occurred in the following cases:
1) Where an LKM program is loaded to the host computer system 100;
2) Where a container is created in the host computer system 100; or
3) Where an operating system of the host computer system 100 is booted.

The detection target acquirer 204 acquires a copy of an LKM program which is being executed on the host computer system 100 as a detection target. In one exemplary embodiment, when the event detector 202 detects the occurrence of the triggering event, the detection target acquirer 204 may acquire the copy of the LKM program. In this case, the copy of the LKM program may be an object dump file which is generated from the LKM program running on the host computer system 100.

The rootkit detector 206 detects whether a rootkit is present in the detection target. In one exemplary embodiment, the rootkit detector 206 may determine whether the rootkit is present in the detection target by determining whether the detection target contains program code for modifying operation of one or more pre-defined kernel functions. For example, the rootkit detector 206 may determine that the kernel functions have been modified if first program code for hooking the one or more kernel functions or second program code for changing a memory address for calling the kernel functions is included in the detection target,

The storage module 208 stores and manages one or more rootkit detection rules required for the rootkit detector 206 to detect whether the rootkit is present. For example, the rule storage 208 may store one or more rootkit detection rules for hooking a particular kernel function or detecting the change of a memory address for calling a kernel function as described above. In one exemplary embodiment, the rootkit detection rules may be described using a regular expression or the like. The rootkit detector 206 may detect whether the rootkit is present in the detection target by applying the one or more rootkit rules stored in the rule storage 208 to the detection target.

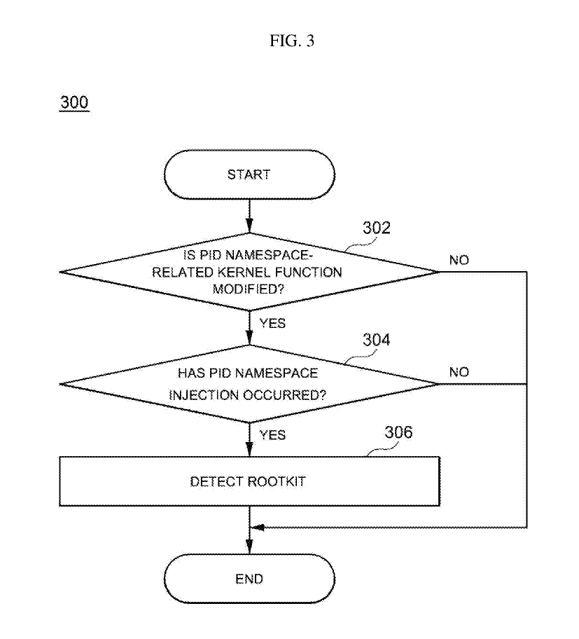

FIGS. 3 to 8 are diagrams for describing in more detail the rootkit detection rules stored in the rule storage 208 in one exemplary embodiment of the present disclosure.

FIG. 3 is a flowchart for describing a detection rule 300 for detecting a PID namespace injection-related rootkit in one exemplary embodiment of the present disclosure.

In operation 302, the detection rule is configured to determine whether there is a modification of a particular kernel function for allocating a process ID (PID) namespace to a container to be newly created in the host computer system 100. For example, in the case of a Linux kernel, the particular kernel function may be copy_pid_ns( ) function or a sub-function called by copy_pid_ns( ) function. Specifically, the detection rule may be configured to determine that copy_pid_ns( ) function has been modified, when a program code for hooking the copy_pid_ns( ) function or changing a memory address for calling the copy_pid_ns( ) function in sys_call_table is included in a detection target.

If it is determined in operation 302 that the modification has occurred, in operation 304, the detection rule is configured to determine whether or not a program code for injecting a process ID of another container, for example, a malicious container, instead of a parent process ID of the newly created container, as a parameter of the particular kernel function (e.g., copy_pid_ns( ) function) is present.

If it is determined in operation 304 that the corresponding program code is present, in operation 306, the detection rule is configured to determine that a rootkit is detected. On the other hand, when the modification of the kernel function is not found in operation 302 or when the program code described above is not found in operation 304, the detection rule is configured to determine that the rootkit is not detected.

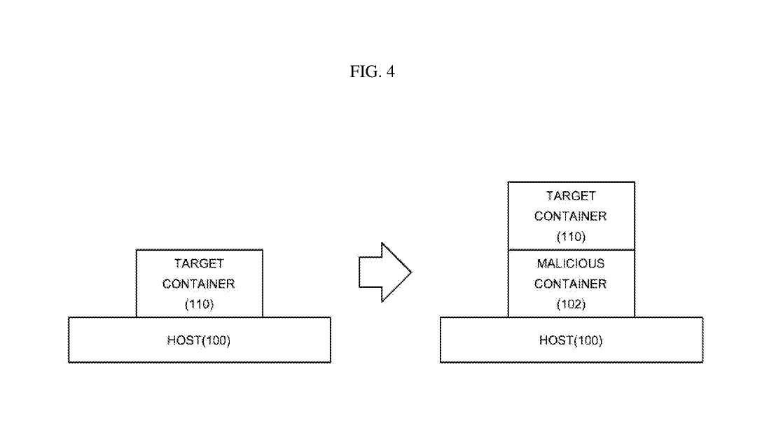

FIG. 4 is a diagram for describing PID namespace injection, which is one of attacking actions of the container rootkit. When a new container is created in the host computer system 100, the host computer system 100 has access to a process of the new container by registering a PID namespace of the new container in a PID namespace hierarchy of the host computer system 100. For example, as shown in FIG. 4, a parent PID namespace of a target container 110 which is newly created in a normal situation becomes a PID namespace of the host computer system 100.

The container rootkit is configured to inject a PID namespace of the malicious container 102, instead of the PID namespace of the host computer system 100, as a parameter of a kernel function, such as the above-described copy_pid_ns( ) As a result, as shown in the right side of FIG. 4, the newly created target container 110 has the PID namespace of the malicious container 102 as a parent PID namespace thereof, and consequently, the malicious container 102 has access to a process of the target container 110. The aforementioned detection rule of FIG. 3 detects whether a rootkit is present in the detection target by checking whether there is a code related to the PID namespace injection.

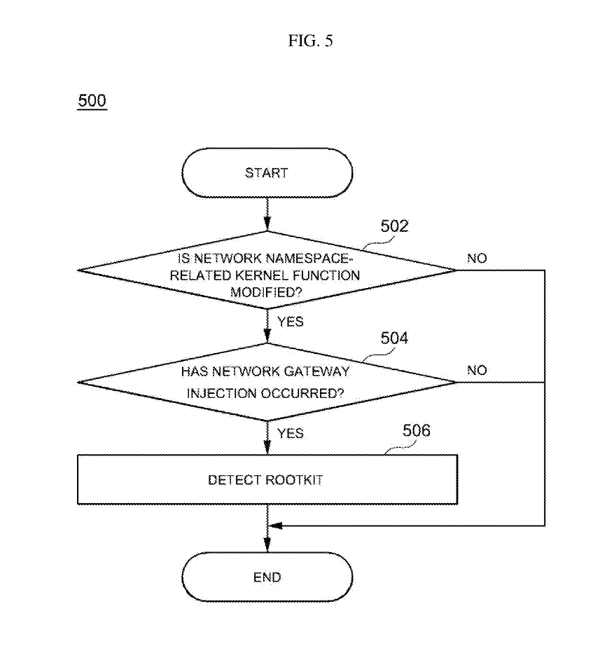

FIG. 5 is a flowchart for describing a detection rule 500 for detecting a network gateway injection-related rootkit in one exemplary embodiment of the present disclosure.

In operation 502, the detection rule 500 is configured to determine whether there is a modification of a particular kernel function for allocating a network namespace to a container to be newly created in the host computer system 100. For example, in the case of a Linux kernel, the particular kernel function may be fib_table_insert( ) function which inserts a network routing path. Specifically, the detection rule may be configured to determine that fib_table_insert( ) function has been modified, when a program code for hooking the fib_table_insert( ) function or changing a memory address for calling the fib_table_insert( ) function in sys_call_table is included.

If it is determined in operation 502 that the modification has occurred, in operation 504, the detection rule is configured to determine whether or not a program code for injecting a network gateway of another container, for example, a malicious container, instead of a network gateway of the newly created container, as a parameter of the particular kernel function (e.g., fib_table_insert( ) function) is present.

If it is determined in operation 504 that the corresponding program code is present, in operation 506, the detection rule is configured to determine that a rootkit is detected. On the other hand, when the modification of the kernel function is not found in operation 502 or when the program code described above is not found in operation 504, the detection rule is configured to determine that the rootkit is not detected.

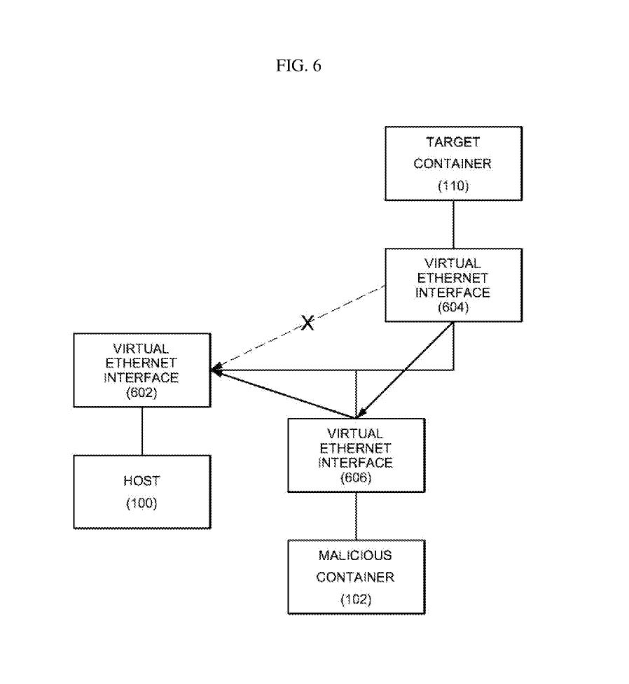

FIG. 6 is a diagram for describing network gateway injection, which is one of attacking actions of a container rootkit. Containers created in the host computer system 100 each have a unique network namespace. In a general operating environment, a default gateway of a network namespace allocated to each of the containers becomes a virtual Ethernet interface 602 of the host computer system 100 (represented by a dashed arrow).

The container rootkit is configured to inject a network gateway of the malicious container 102, instead of a network gateway of the host computer system 100, as a parameter of a kernel function, such as the above-described fib_table_insert( ). As a result, as shown in FIG. 6, packets transmitted and received through a virtual Ethernet interface 604 of the newly created target container 110 pass through a virtual Ethernet interface 604 of the malicious container 102 (represented by a solid arrow), so that the malicious container 102 is allowed to ‘see’ all packets of the target container 110 (packet sniffing). The aforementioned detection rule of FIG. 5 detects whether a rootkit is present in the detection target by checking whether there is a code related to the network gateway injection.

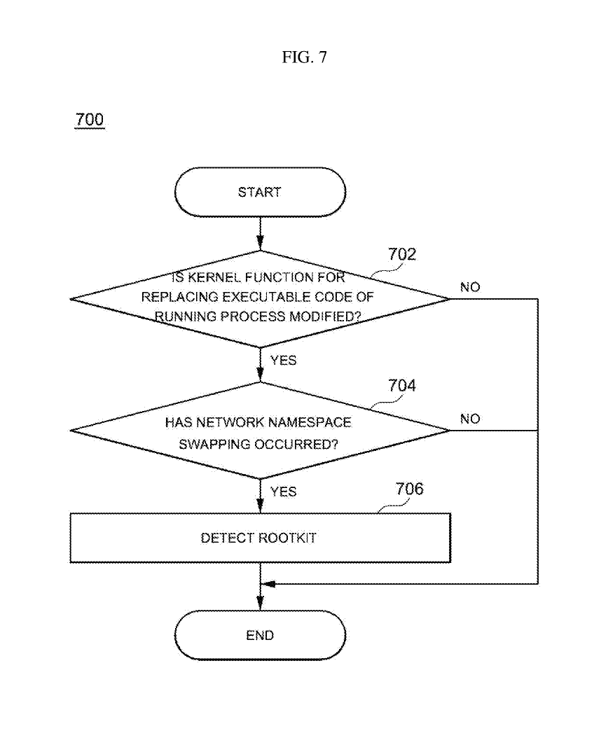

FIG. 7 is a flowchart for describing a detection rule 700 for detecting a network namespace swapping-related rootkit in one exemplary embodiment of the present disclosure.

In operation 702, the detection rule is configured to determine whether there is a modification of a particular kernel function for replacing at least a part of executable code of a process being executed in the host computer system 100. For example, in the case of a Linux kernel, the particular kernel function may be execve( ) function. Specifically, the detection rule may be configured to determine that execve( ) function has been modified, when a program code for hooking the execve( ) function or changing a memory address for calling the execve( ) function in sys_call_table is included in a detection target.

If it is determined in operation 792 that the modification has occurred, in operation 704, the detection rule is configured to determine whether a program code for swapping network namespace information of a particular container, for example, a malicious container, to network namespace information of another container, other than the particular container, is included in the detection target. Specifically, the detection rule may be configured to determine whether a program code for swapping net_ns, which is a data structure including the network namespace information, in an nsproxy struct corresponding to the particular container to net_ns of the other container is included in the detection target.

If it is determined in operation 704 that the corresponding program code is included, in operation 706, the detection rule is configured to determine that a rootkit is detected. On the other hand, when the modification of the kernel function is not found in operation 702 or when the program code described above is not found in operation 704, the detection rule is configured to determine that the rootkit is not detected.

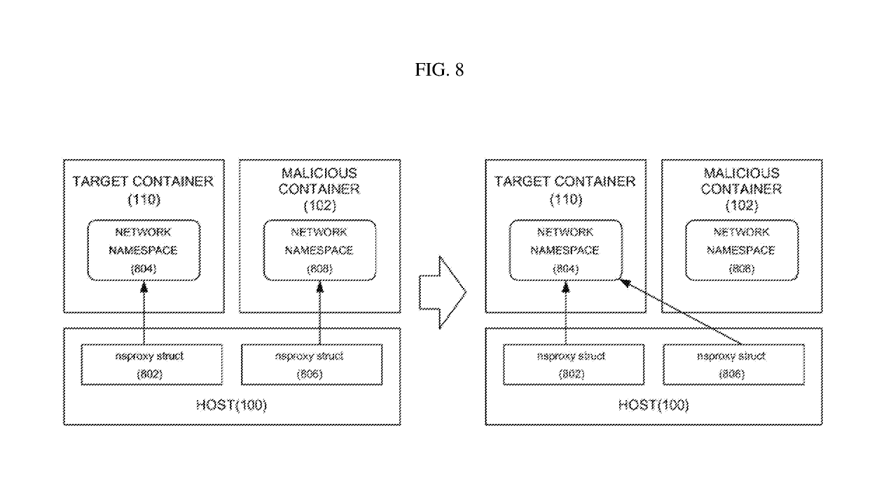

FIG. 8 is a diagram for describing network namespace swapping, which is one of attacking actions of a container rootkit. Containers created in the host computer system 100 each have a unique network namespace. Network namespace information of each of the containers is stored in net_ns data structure in an nsproxy struct corresponding to a corresponding container. For example, as shown in the left side of FIG. 8, an nsproxy struct 802 corresponding to the target container 110 includes information about network namespace 804 of the target container 110, and an nsproxy struct 806 corresponding to the malicious container 102 includes information about network namespace 808 of the malicious container 102.

The container rootkit is configured to swap net_ns, which is a data structure including the network namespace information, in the nsproxy struct 806 corresponding to the malicious container 102 to net_ns of the target container 110 (right side of FIG. 8). As a result, an attacker is able to perform an attack, such as network sniffing or spoofing, on the target container 110 using the modified particular kernel function (e.g., execve( ) function). The aforesaid detection rule of FIG. 7 detects whether a rootkit is present in the detection target by checking whether there is a code related to the network namespace swapping.

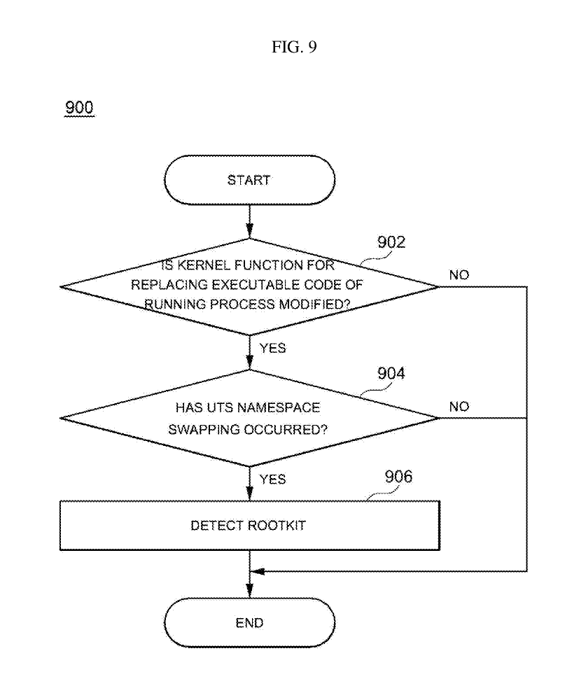

FIG. 9 is a flowchart for describing a detection rule 900 for detecting UTS namespace swapping-related rootkit in one exemplary embodiment of the present disclosure.

In operation 902, the detection rule is configured to determine whether there is a modification of a particular kernel function for replacing at least a part of executable code of a process being executed in the host computer system 100. For example, in the case of a Linux kernel, the particular kernel function may be execve( ) function. Specifically, the detection rule may be configured to determine that execve( ) function has been modified, when a program code for hooking the execve( ) function or changing a memory address for calling the execve( ) function in sys_call_table is included in a detection target.

If it is determined in operation 902 that the modification has occurred, in operation 904, the detection rule is configured to determine whether a program code for swapping uts_ns, which is a data structure including UTS namespace information, in an nsproxy struct corresponding to the particular container to uts_ns of another container is included in the detection target.

If it is determined that in operation 904 that the corresponding program code is included, in operation 906, the detection rule is configured to determine that a rootkit is detected. On the other hand, when the modification of the kernel function is not found in operation 902 or when the program code described above is not found in operation 904, the detection rule is configured to determine that the rootkit is not detected.

In a similar way to the network namespace swapping, the container rootkit can swap uts_ns, which is a data structure including UTS namespace information, in an nsproxy struct 806 corresponding to the malicious container 102 to uts_ns of the target container 110. As a result, the attacker is able to impersonate the target container 110 by using a host name and a domain name of the target container 110. The aforesaid detection rule of FIG. 9 detects whether the rootkit is present in the detection target by checking whether there is a code related to the UTS gateway swapping.

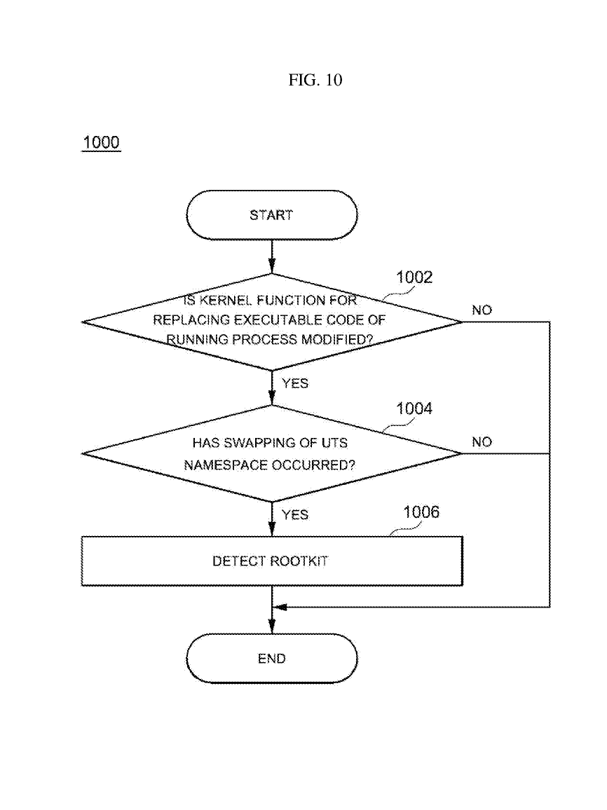

FIG. 10 is a flowchart for describing a detection rule 1000 for detecting a rootkit related to virtual file system (VFS) swapping in one exemplary embodiment of the present disclosure.

In operation 1002, the detection rule is configured to determine whether there is a modification of a particular kernel function for replacing at least a part of executable code of a process being executed in the host computer system 100. For example, in the case of a Linux kernel, the particular kernel function may be execve( ) function. Specifically, the detection rule may be configured to determine that execve( ) function has been modified, when a program code for hooking the execve( ) function or changing a memory address for calling the execve( ) function in sys_call_table is included in a detection target.

If it is determined in operation 1002 that the modification has occurred, in operation 1004, the detection rule is configured to determine whether a program code for swapping VFS information of a particular container, for example, a malicious container, to VFS information of another container, other than the particular container, is included in the detection target. Specifically, the detection rule may be configured to determine whether a program code for swapping fs_structu, which is a VFS struct corresponding to the particular container, to fs_struct of the other container is included in the detection target.

If it is determined in operation 1004 that the corresponding program code is included, in operation 1006, the detection rule is configured to determine that a rootkit is detected. On the other hand, when the modification of the kernel function is not found in operation 1002 or when the program code described above is not found in operation 1004, the detection rule is configured to determine that the rootkit is not detected.

The above-described VFS is a subsystem of a kernel implemented to provide a file system interface to a program in a user domain. When fs_struct of the malicious container 102 is swapped to fs_struct of the target container 102, the attacker is able to perform an attack, such as keyloagger, by using a kernel function, such as modified execve( ). The aforesaid detection rule of FIG. 10 detects whether a rootkit is present in a detection target by checking whether there is a code related to the VFS swapping.

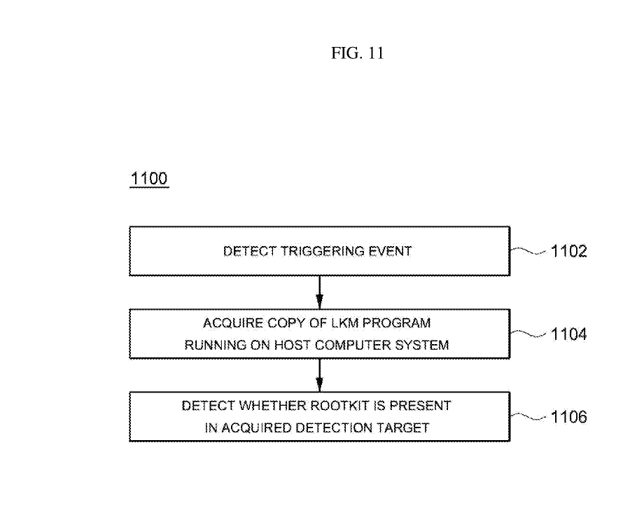

FIG. 11 is a flowchart for describing a method 1100 of detecting a rootkit according to one exemplary embodiment of the present disclosure. The method shown in FIG. 11 may be performed by, for example, the above-described apparatus 200 for detecting a rootkit. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 1102, the event detector 202 of the apparatus 200 for detecting a rootkit detects the occurrence of a triggering event in the host computer system 100. The detailed configuration related to the triggering event is as described above.

In operation 1104, the detection target acquirer 204 of the apparatus 200 acquires a copy of an LKM program which is being executed on the host computer system 100 as a detection target. As described above, the detection target acquirer 204 may acquire the copy of the LKM program when the occurrence of the triggering event is detected in operation 1102. In this case, the copy of the LKM program may be an object dump file created from the LKM program.

In operation 1106, the rootkit detector 206 of the apparatus 200 detects whether a rootkit is present in the acquired detection target. In this case, the rootkit detector 206 may detect whether the rootkit is present in the detection target by using one or more rootkit detection rules stored in the rule storage 208. Specifically, when a program code for hooking kernel functions or changing a memory address for calling the kernel functions is included in the detection target, the rootkit detector 206 may determine that the kernel functions have been modified. When the rootkit is found in the detection target in operation 1106, the rootkit detector 206 may transmit an alarm message to an administrator or the like.

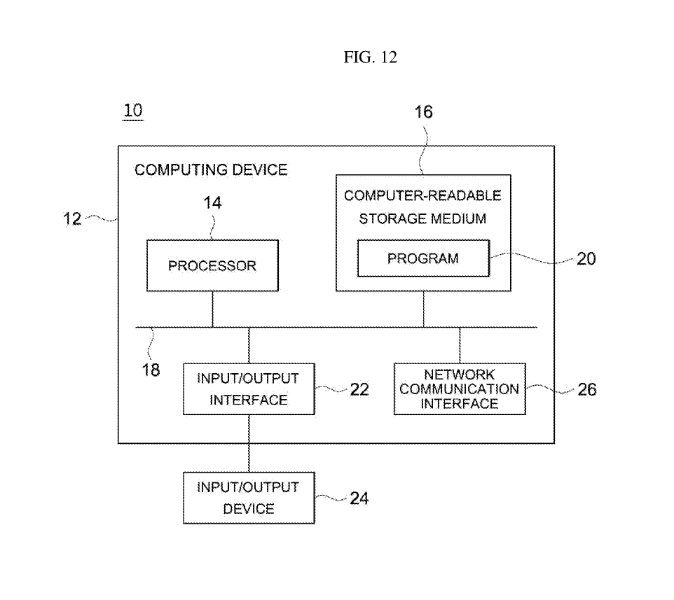

FIG. 12 is a block diagram for describing a computing environment 10 in which a computing device suitable to be used in the exemplary embodiments is included. In the illustrated embodiment, components each may provide different functions and capabilities as well as the functions and capabilities described herein, and extra components may be included in addition to those described below. The illustrated computing environment 10 includes the computing device 12. In one exemplary embodiment, the computing device 12 may be an apparatus 200 for detecting a rootkit. The computing device 12 may include at least one processor 14, a computer-readable recording medium 16, and a communication bus 18. The processor 14 may cause the computing device 12 to operate in accordance with the aforementioned exemplary embodiments. For example, the processor 14 may execute one or more programs 20 stored in the computer-readable storage medium 16. The one or more programs 20 may include one or more computer-executable instructions, which, when executed by the processor 14, cause the computing device 12 to perform operations in accordance with the exemplary embodiments. The computer-readable storage medium 16 is configured to store computer-executable instructions, program code, program data, and/or other suitable forms of information. The program 20 stored in the computer-readable storage medium 16 includes a set of instructions executable by the processor 14. In one exemplary embodiment, the computer-readable storage medium 16 may be memory (volatile memory, such as random access memory (RAM), non-volatile memory, or any suitable combination thereof), one or more magnetic disk storage devices, optical disk storage devices, flash memory devices, other forms of storage media accessible by the computing device 12 and capable of storing desired information, or any suitable combination thereof.

The communication bus 18 interconnects other components of the computing device 12 including the processor 14 and the computer-readable storage medium 16. The computing device 12 may include one or more input/output interfaces 22 configured to provide interfaces for one or more input/output devices, and one or more network communication interfaces 26. The input/output interfaces 22 and the network communication interfaces 26 are connected to the communication bus 18. The input/output device 24 may be connected to other components of the computing device 12 through the input/output interface 22. The exemplary input/output device 24 may include a pointing device (a mouse, a trackpad, or the like), a keyboard, a touch input device (a touchpad, a touch screen, or the like), a voice or sound input device, an input device, such as a variety of sensor devices and/or an image capturing device, and/or an output device, such as a display device, a printer, a speaker and/or a network card. The exemplary input/output device 24 may be included in the computing device 12 as one component constituting the computing device 12, or may be connected to the computing device 12 as an independent device separate from the computing device 12.

According to the exemplary embodiments of the present disclosure, it is possible to effectively detect a kernel level rootkit that exploits a vulnerability of a Linux container system.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### REFERENCE NUMERALS

100: host computer system
102: malicious container
104: container rootkit
106: system call table
108: kernel function
110: target container
200: apparatus for detecting rootkit
202: detection target acquirer
206: rootkit detector
208: rule storage

What is claimed is:

1. An apparatus for detecting a rootkit, comprising:
at least one processor configured to implement:
a detection target acquirer configured to acquire, as a detection target, a copy of a kernel module program configured to be executed on a host computer system, wherein the host computer system is configured to run one or more containers; and
a rootkit detector configured to detect whether a rootkit is present in the detection target based on whether the detection target contains program code for modifying operation of a pre-defined kernel function.

2. The apparatus of claim 1, wherein the copy is an object dump file created from the kernel module program.

3. The apparatus of claim 1, wherein the at least one processor further implements an event detector configured to detect a triggering event in the host computer system, and wherein the detection target acquirer is configured to acquire the copy of the kernel module program when the event detector detects the triggering event.

4. The apparatus of claim 3, wherein the triggering event includes at least one of: i) the kernel module program being loaded to the host computer system, ii) a new container being created in the host computer system, or iii) an operating system of the host computer system being booted.

5. The apparatus of claim 1, wherein the rootkit detector is configured to detect the program code based on a presence of at least one of:
first program code in the detection target for hooking the pre-defined kernel function, or
second program code in the detection target for changing a memory address for calling the pre-defined kernel function.

6. The apparatus of claim 5, wherein the rootkit detector is configured to determine that the rootkit is present in the detection target when the pre-defined kernel function is for allocating a process ID (PID) namespace to a first container newly created in the host computer system, and
the detection target contains additional program code for injecting a PID of a second container, which is distinguished from the first container, as a parameter of the pre-defined kernel function.

7. The apparatus of claim 5, wherein the rootkit detector is configured to determine that the rootkit is present in the detection target when the pre-defined kernel function is for allocating a network namespace to a first container newly created in the host computer system is detected, and
the detection target contains additional program code for injecting a gateway address of a second container, which is distinguished from the first container, as a parameter of the pre-defined kernel function.

8. The apparatus of claim 5, wherein the rootkit detector is configured to determine that the rootkit is present in the detection target when the pre-defined kernel function is for replacing at least a part of executable code configured to be executed on the host computer system, and
the detection target contains additional program code for swapping network namespace information of a first container to network namespace information of a second container, which is distinguished from the first container.

9. The apparatus of claim 5, wherein the rootkit detector is configured to determine that the rootkit is present in the detection target when the pre-defined kernel function is for replacing at least a part of executable code configured to be executed on the host computer system, and
the detection target contains additional program code for swapping Unix TimeSharing System (UTS) namespace information of a first container to UTS namespace information of a second container, which is distinguished from the first container.

10. The apparatus of claim 5, wherein the rootkit detector is configured to determine that the rootkit is present in the detection target when the pre-defined kernel function is for replacing at least a part of executable code of the host computer system, and
the detection target contains additional program code for swapping virtual file system information of a first container to virtual file system information of a second container, which is distinguished from the first container.

11. A method of detecting a container rootkit which is performed by a computing device including one or more processors and a memory, wherein the memory includes one or more programs to be executed by the one or more processors, the method comprising:
acquiring, as a detection target, a copy of a kernel module program configured to be executed on a host computer system, wherein the host computer system is configured to run one or more containers; and
detecting whether a rootkit is present in the detection target based on whether the detection target includes program code for modifying operation of a pre-defined kernel function.

12. The method of claim 11, wherein the copy is an object dump file created from the kernel module program.

13. The method of claim 11, further comprising, before acquiring the detection target:
detecting a triggering event in the host computer system,
wherein the acquiring of the detection target comprises acquiring the copy of the kernel module program when the triggering event is detected.

14. The method of claim 13, wherein the triggering event is at least one of: i) the kernel module program being loaded to the host computer system, ii) a new container being created in the host computer system, or iii) an operating system of the host computer system being booted.

15. The method of claim 11, wherein the program code includes at least one of:
first program code in the detection target for hooking the pre-defined kernel function, or
second program code in the detection target for changing a memory address for calling the pre-defined kernel function.

16. The method of claim 15, wherein the detecting of the rootkit comprises determining that the rootkit is present in the detection target, when the pre-defined kernel function is for allocating a process ID (PID) namespace to a first container newly created in the host computer system, and
the detection target contains additional program code for injecting a PID of a second container, which is distinguished from the first container, as a parameter of the pre-defined kernel function.

17. The method of claim 15, wherein the detecting of the rootkit comprises determining that the rootkit is present in the detection target, when the pre-defined kernel function is for allocating a network namespace to a first container newly created in the host computer system, and
the detection target contains additional program code for injecting a gateway address of a second container, which is distinguished from the first container, as a parameter of the pre-defined kernel function.

18. The method of claim 15, wherein the detecting of the rootkit comprises determining that the rootkit is present in the detection target, when the pre-defined kernel function is for replacing at least a part of executable code of the host computer system, and
the detection target contains additional program code for swapping network namespace information of a first container to network namespace information of a second container, which is distinguished from the first container.

19. The method of claim 15, wherein the detecting of the rootkit comprises determining that the rootkit is present in the detection target, when the pre-defined kernel function is for replacing at least a part of executable code of the host computer system, and
the detection target contains additional program code for swapping Unix TimeSharing System (UTS) namespace information of a first container to UTS namespace information of a second container, which is distinguished from the first container.

20. The method of claim 15, wherein the detecting of the rootkit comprises determining that the rootkit is present in the detection target, when the pre-defined kernel function is for replacing at least a part of executable code of the host computer system, and
the detection target contains additional program code for swapping virtual file system information of a first container to virtual file system information of a second container, which is distinguished from the first container.
